(19) United States
(12) Patent Application Publication
(10) Pub. No.: US 2016/0270118 A1
(43) Pub. Date: Sep. 15, 2016

(54) LOW-LATENCY TIME-SHARING MEDIA ACCESS CONTROL

(71) Applicant: QUALCOMM Incorporated, San Diego, CA (US)

(72) Inventors: Linhai HE, San Diego, CA (US); Rashid Ahmed Akbar Attar, San Diego, CA (US); Bibhu Mohanty, San Diego, CA (US); Maksim Krasnyanskiy, San Diego, CA (US); Yacob Cohen-Arazi, San Diego, CA (US); Rajesh Kumar, San Diego, CA (US); Ron Schneider, Carlsbad, CA (US); Wenjia Lai, San Diego, CA (US); Joseph Binamira Soriaga, San Diego, CA (US)

(21) Appl. No.: 15/066,967

(22) Filed: Mar. 10, 2016

Related U.S. Application Data
(60) Provisional application No. 62/133,152, filed on Mar. 13, 2015.

(51) Int. Cl. H04W 74/06; H04W 36/00; H04W 36/38

(52) U.S. Cl. CPC H04W 74/06; H04W 36/38; H04W 36/0061; H04W 84/12

(57) ABSTRACT

Various aspects are provided for low-latency wireless local area networks. In a aspect, an access point (AP) may select, from a plurality of wireless stations associated with the AP, a wireless station for the AP to poll. Each of the plurality of wireless stations may be configured to transmit on a channel in response to being polled by the AP. The AP may transmit, at a time selected by the AP, a downlink frame including polling information to the wireless station on the channel, the polling information including a permitted duration for the wireless station to access the channel. The AP may monitor during the permitted duration for the AP to receive an uplink transmission from the wireless station on the channel, the uplink transmission from the wireless station being in response to the polling information received by the wireless station.

### RELATED APPLICATIONS

This application claims priority from U.S. Provisional Application No. 62/133,152 entitled “LOW-LATENCY TIME-SHARING MEDIA ACCESS CONTROL,” filed on Mar. 13, 2015, which is incorporated herein by reference in its entirety.

### BACKGROUND

The present disclosure relates generally to telecommunications, and specifically to low-latency wireless local area networks.

The deployment of wireless local area networks (WLANs) in the home, the office, and various public facilities is commonplace today. Such networks typically employ a wireless access point (AP) that connects a number of wireless stations (STAs) in a specific locality (e.g., home, office, public facility, etc.) to another network, such as the Internet or the like. A set of STAs can communicate with each other through a common AP in what is referred to as a basic service set (BSS). Nearby BSSs may have overlapping coverage areas and such BSSs may be referred to as overlapping BSSs or OBSSs.

For some applications, the latency of existing WLANs may be too high. For example, industrial applications involving sensors and/or robotic controls may have a need to transmit control data with very low latency. Existing media access control (MAC) protocols, however, may be optimized to maximize throughput at the expense of latency. Accordingly, control data, which may be relatively small in size, may be delayed by buffering, overhead, and other characteristics of existing MAC protocols. Further, some low-latency applications may incorporate numerous wireless stations. Existing MAC protocols may permit collisions between transmissions between different stations. As more stations are added, the number of collisions increases and results in greater latency. Accordingly, it may be desirable to provide a WLAN that supports reliable low-latency applications for numerous wireless stations.

### SUMMARY

Various aspects are provided for low-latency wireless local area networks. An access point (AP) may select, from a plurality of wireless stations associated with the AP, a wireless station for the AP to poll. Each of the plurality of wireless stations may be configured to transmit on a channel in response to being polled by the AP. The AP may transmit, at a time selected by the AP, a downlink frame including polling information to the wireless station on the channel, the polling information including a permitted duration for the wireless station to access the channel. The AP may monitor during the permitted duration for the AP to receive an uplink transmission from the wireless station on the channel, the uplink transmission from the wireless station being in response to the polling information received by the wireless station.

In an aspect, the disclosure provides a method for wireless communications. The method may include selecting, from a plurality of wireless stations associated with an access point AP, a wireless station for the AP to poll, wherein each of the plurality of wireless stations is configured to transmit on a channel in response to being polled by the AP. The method may further include transmitting, at a time selected by the AP, a downlink frame including polling information to the wireless station on the channel, the polling information including a permitted duration for the wireless station to access the channel. The method may also include monitoring the channel, during the permitted duration, for the AP to receive an uplink transmission from the wireless station, the uplink transmission from the wireless station being in response to the polling information received by the wireless station.

In an aspect, the disclosure provides a method of wireless communications. The method may include monitoring, by a wireless station, a wireless channel for a first downlink transmission from a first AP. The method may further include determining that the first downlink transmission includes polling information identifying the wireless station and a permitted duration for the wireless station to access the channel. The method may also include transmitting an uplink transmission on the wireless channel within the permitted duration based on the polling information.

In an aspect, the disclosure provides an apparatus for wireless communications. The apparatus may include a transceiver, a memory that stores instructions, and a processor communicatively coupled to the transceiver and the memory. The processor may be configured to execute the instructions to select, from a plurality of wireless stations associated with an AP, a wireless station for the AP to poll. Each of the plurality of wireless stations may be configured to transmit on a channel in response to being polled by the AP. The processor may also be configured to execute the instructions to transmit, via the transceiver, at a time selected by the AP, a downlink frame including polling information to the wireless station on the channel. The polling information may include a permitted duration for the wireless station to access the channel. The processor may also be configured to execute the instructions to monitor the channel, during the permitted duration, for the AP to receive an uplink transmission from the wireless station on the channel. The uplink transmission from the wireless station may be in response to the polling information received by the wireless station.

In an aspect, the disclosure provides another apparatus for wireless communications. The apparatus may include means for selecting, from a plurality of wireless stations associated with an AP, a wireless station for the AP to poll, wherein each of the plurality of wireless stations is configured to transmit on a channel in response to being polled by the AP. The apparatus may also include means for transmitting, at a time selected by the AP, a downlink frame including polling information to the wireless station on the channel, the polling information including a permitted duration for the wireless station to access the channel. The apparatus may further include means for monitoring the channel, during the permitted duration, for the AP to receive an uplink transmission from the wireless station, the uplink transmission from the wireless station being in response to the polling information received by the wireless station.

In an aspect, the disclosure provides a computer-readable medium storing computer executable code for wireless communications. The computer-readable medium may include code for selecting, from a plurality of wireless stations associated with an AP, a wireless station for the AP to poll, wherein each of the plurality of wireless stations is configured to transmit on a channel in response to being polled by the AP. The computer-readable medium may also include code for transmitting, at a time selected by the AP, a downlink frame including polling information to the wireless station on the channel, the polling information including a permitted duration for the wireless station to access the channel. The computer-readable medium may further include code for monitoring the channel, during the permitted duration, for the AP to receive an uplink transmission from the wireless station, the uplink transmission from the wireless station being in response to the polling information received by the wireless station.

In an aspect, the disclosure provides an apparatus for wireless communications. The apparatus may include a transceiver configured to monitor a wireless channel for a first downlink transmission from a first AP to a wireless station. The apparatus may also include a memory that stores instructions and a processor communicatively coupled to the memory. The processor may be configured to execute the instructions to determine that the first downlink transmission includes polling information identifying the wireless station and a permitted duration for the wireless station to access the wireless channel. The processor may also be configured to execute the instructions to transmit an uplink transmission on the wireless channel within the permitted duration based on the polling information.

In an aspect, the disclosure provides an apparatus for wireless communications. The apparatus may include means for monitoring, by a wireless station, a wireless channel for a first downlink transmission from a first AP. The apparatus may further include means for determining that the first downlink transmission includes polling information identifying the wireless station and a permitted duration for the wireless station to access the channel. The apparatus may also include means for transmitting an uplink transmission on the wireless channel within the permitted duration based on the polling information.

In an aspect, the disclosure provides a computer-readable medium storing computer-executable code for wireless communications. The computer-readable medium may include code for monitoring, by a wireless station, a wireless channel for a first downlink transmission from a first AP. The computer-readable medium may include code for determining that the first downlink transmission includes polling information identifying the wireless station and a permitted duration for the wireless station to access the channel. The computer-readable medium may include code for transmitting an uplink transmission on the wireless channel within the permitted duration based on the polling information.

It is understood that other aspects of apparatuses and methods will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1 is a conceptual diagram illustrating an example of a wireless local area network (WLAN) deployment;

FIG. 2 is a timing diagram illustrating an example of a channel structure for a low-latency serving channel.

FIG. 3 is a block diagram illustrating an example access point;

FIG. 4 is a block diagram illustrating an example wireless station;

FIG. 5A is a diagram illustrating an example downlink frame;

FIG. 5B is a diagram illustrating an example uplink frame;

FIG. 6 is a flow chart illustrating an example of aspects of a method performed by an AP for providing low-latency asynchronous communications;

FIG. 7 is a flow chart illustrating an example of aspects of a another method performed by an AP for providing low-latency asynchronous communications;

FIG. 8 is a flow chart illustrating an example of aspects of another method performed by an AP for providing low-latency asynchronous communications;

FIG. 9 a flow chart illustrating an example of aspects of a method performed by a wireless station for providing low-latency asynchronous communications;

FIG. 10 is a block diagram illustrating an example of a rate control component;

FIG. 11 is a conceptual diagram illustrating examples of frame error rate (FER)/signal-to-noise ration (SNR) curves;

FIG. 12 a flow chart illustrating an example of aspects of a method of determining a modulation and coding scheme;

FIG. 13 is a message diagram illustrating an example of a method for performing handover of a station;

FIG. 14 is a message diagram illustrating an example of another method for performing handover of a station;

FIG. 15 is a message diagram illustrating an example of another method for performing handover of a station; and

FIG. 16 is a block diagram illustrating an example of a processing system configured for providing low-latency communications.

### DETAILED DESCRIPTION

Various concepts will be described more fully hereinafter with reference to the accompanying drawings. These concepts may, however, be embodied in many different forms by those skilled in the art and should not be construed as limited to any specific structure or function presented herein. Rather, these concepts are provided so that this disclosure will be thorough and complete, and will fully convey the scope of these concepts to those skilled in the art. The detailed description may include specific details. However, it will be apparent to those skilled in the art that these concepts may be practiced without these specific details. In some instances, well known structures and components are shown in block diagram form in order to avoid obscuring the various concepts presented throughout this disclosure.

The present disclosure describes various aspects for providing a WLAN that supports low-latency applications. In an aspect, a network that supports low-latency applications may have a goal of providing wireless communications with a round-trip time of, for example, less than 2 milliseconds. For comparison, a Wi-Fi network with a single wireless station may have a round-trip time of at least 1.5 milliseconds. As the number of Wi-Fi stations grows, the number of collisions may grow quickly and further increase the round-trip time. For simplicity, a WLAN or network that supports low-latency applications may be referred to as a low-latency WLAN or a low-latency network, respectively.

The aspects provided in the present disclosure for providing a low-latency WLAN may include multiple methods that can be used to reduce or minimize latency associated with wireless communications. In one of these methods, an asynchronous media access control protocol may be used for both uplink and downlink communications over a wireless channel (e.g., a frequency band). An AP may schedule all transmissions on the channel using polling to reduce latency by avoiding collisions between transmissions from different stations. The AP may flexibly schedule transmissions of various lengths depending on the needs of the system. When transmissions are completed early, the AP may immediately schedule another transmission. Wireless stations may be configured to transmit on the channel only when polled by the AP. The AP may rapidly poll each station to allow each station to transmit data in the uplink direction. The polling message may also include downlink data, or downlink data may be sent in separate messages scheduled by the AP.

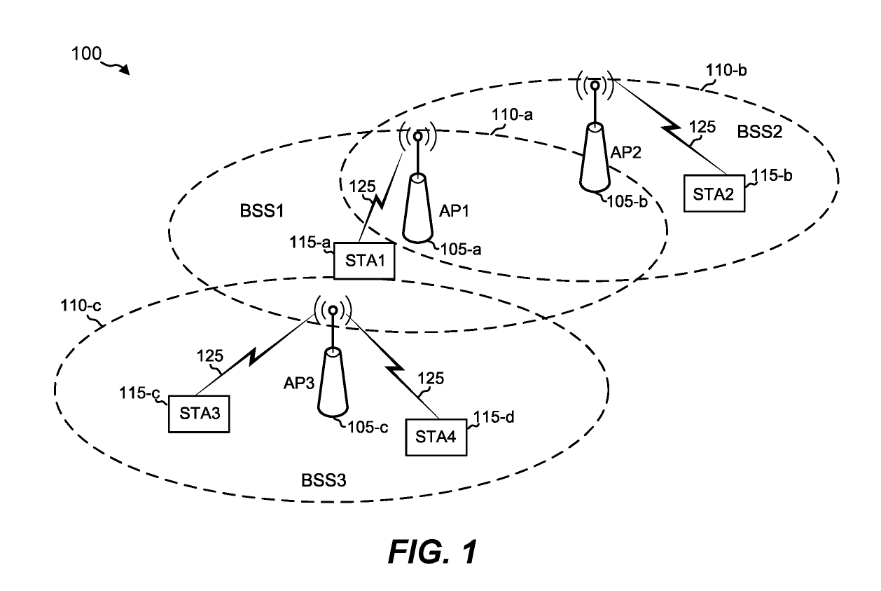

FIG. 1 is a conceptual diagram 100 illustrating an example of a wireless local area network (WLAN) deployment that may provide a low-latency WLAN. The WLAN may include one or more access points (APs) and one or more mobile stations (STAs) associated with a respective AP. In this example, there are three APs deployed: AP1 105-a in basic service set 1 (BSS1), AP2 105-b in BSS2, and AP3 105-c in BSS3. AP1 105-a may have an associated STA1 115-a and coverage area 110-a, AP2 105-b may have an associated STA2 115-b and coverage area 110-b, and AP3 105-c may have associated STA3 115-c and STA4 115-d and coverage area 110-c. In this example, the coverage area of AP1 overlaps part of the coverage area of AP2 such that AP1 and AP2 are within the overlapping portion of the coverage areas. In addition, the coverage area of AP1 also overlaps part of the coverage area of AP3; however, neither AP1 nor AP3 is within the overlapping portion of the coverage areas. Thus, while transmissions from AP1 may reach AP2 and vice versa, transmissions from AP1 and AP3 may not reach each other. The number of BSSs, APs, and STAs, and the coverage areas of the APs described in connection with the WLAN deployment of FIG. 1 are provided by way of illustration and not of limitation. Moreover, aspects of the different methods for providing low-latency communications are described based on the example WLAN deployment of FIG. 1.

The APs (e.g., AP1 105-a, AP2 105-b, AP3 105-c) shown in FIG. 1 are generally fixed terminals that provide backhaul services to STAs within its coverage area or region. In some applications, however, the AP may be a mobile or non-fixed terminal.

The STAs (e.g., STA1 115-a, STA2 115-b, STA3 115-c, and STA4 115-d) shown in FIG. 1, which may be fixed, non-fixed, or mobile terminals, utilize the backhaul services of their respective AP to connect to a network, such as the Internet. The STAs may also communicate between themselves and/or with a control station, which may be connected to one or more APs via a backhaul. Examples of an STA include, but are not limited to: a cellular phone, a smart phone, an industrial robot, a manufacturing control system, a sensor, a drone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the central communication coordination and/or backhaul services of an AP. In an aspect, a STA may execute a low-latency application that may benefit from network communications with low round-trip times. For example, a low-latency application may include a remote control application, a coordination application, or another application involving time-sensitive information. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, user equipment (UE), or some other suitable terminology. An AP may also be referred to as: a base station, a base transceiver station, a radio base station, a radio transceiver, a transceiver function, or any other suitable terminology. The various concepts described throughout this disclosure are intended to apply to any suitable wireless apparatus regardless of its specific nomenclature.

In an aspect, one or more of the APs (e.g., AP1 105-a) may be an authorization AP used to grant access to the low-latency WLAN. For example, an authorization AP may communicate with STAs using a traditional IEEE 802.11 (Wi-Fi) protocol on a dedicated boot-up wireless channel. An STA (e.g., STA1 115-a) may access the authorization AP by performing a random access procedure on the boot-up wireless channel. The authorization AP 105-a may perform authentication and authorization procedures with the STA to ensure the STA is allowed to access the low-latency WLAN. The authorization AP 105-a may then handover the STA to a serving AP (e.g., AP2 105-b, AP3 105-c) for low-latency communications on a low-latency serving channel. A low-latency serving channel may be a frequency band dedicated to a low-latency MAC protocol. In an aspect, each serving AP may be configured to use a different low-latency serving channel from neighboring APs with which the coverage areas overlaps.

Each of STA1 115-a, STA2 115-b, STA3 115-c, and STA4 115-d may be implemented with a protocol stack. The protocol stack can include a physical layer for transmitting and receiving data in accordance with the physical and electrical specifications of the wireless channel, a media access control (MAC) layer for managing access to the wireless channel, a network layer for managing source to destination data transfer, a transport layer for managing transparent transfer of data between end users, and any other layers necessary or desirable for establishing or supporting a connection to a network.

Each of AP1 105-a, AP2 105-b, and AP3 105-c can include software applications and/or circuitry to enable associated STAs to connect to a network via communication links 125. The APs can send frames to their respective STAs and receive frames from their respective STAs to communicate data and/or control information (e.g., signaling).

Each of AP1 105-a, AP2 105-b, and AP3 105-c can establish a communication link 125 with an STA that is within the coverage area of the AP. Communication links 125 can comprise communications channels that can enable both uplink and downlink communications. When a STA has been handed over to a serving AP, the STA may be associated with the serving AP. Once associated, a communication link 125 can be established between the AP and the STA such that the AP and the associated STA can exchange frames or messages through a direct communications channel. The communication channel for each AP may be shared among any STAs associated with the AP. Neighbor APs that have overlapping coverage area with an AP may be configured to use different channels. For example, each of AP1 105-a, AP2 105-b, and AP3 105-c may each use a different channel. In an aspect where a low-latency network includes additional APs that do not have overlapping coverage areas with AP1 105-a, AP2 105-b, and AP3 105-c, the additional AP may reuse a channel of an AP when the respective coverage areas of the APs do not overlap.

A serving AP (e.g., AP2 105-b) may provide for wireless communications. The AP2 105-b may select, from a plurality of STAs 115 associated with AP2 105-b, a STA 115 (e.g., STA2 115-b) for the AP2 105-b to poll, wherein each of the plurality of STAs is configured to transmit on a communication link 125 only when polled. AP2 105-b may transmit a downlink frame including polling information to the STA2 115-b on the communication link 125. AP2 105-b may receive an acknowledgment that the polling information was received by the STA2 115-b. AP2 105-b may start a timer for the AP2 105-b to receive an uplink transmission from STA2 115-b on the communication link 125, the uplink transmission from the STA2 115-b being in response to the polling information received by the STA2 115-b.

The STA2 115-b may perform wireless communications according to a low-latency MAC protocol. The STA2 115-b may monitor a communication link 125 for a downlink transmission from AP2 105-b. The STA2 115-b may determine that the downlink transmission includes polling information identifying STA2 115-b. STA2 115-b may transmit an acknowledgment of the downlink transmission on the communication link. STA2 115-b may transmit an uplink transmission on the communication link 125 based on the polling information.

While aspects for providing a low-latency network are described in connection with a WLAN deployment or the use of IEEE 802.11-compliant networks and related terminology, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed. Thus, the various aspects presented throughout this disclosure for protecting the reception of response frames or messages from interference or similar effects resulting from transmissions by nearby devices may be applicable to any suitable wireless network regardless of the coverage range and the wireless access protocols utilized.

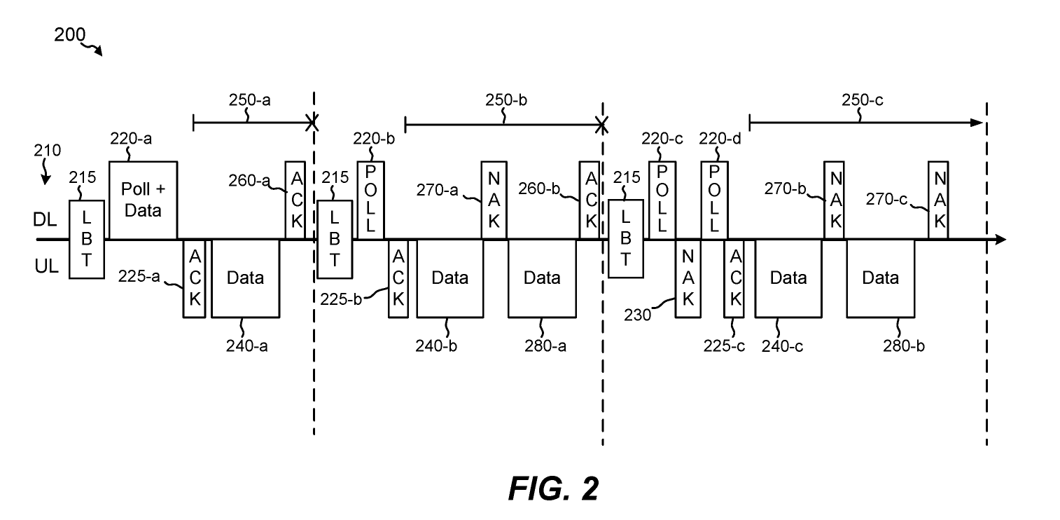

FIG. 2 shows a timing diagram 200 illustrating an example of a channel structure 210 for a low-latency serving channel. As shown in FIG. 2, downlink and uplink transmissions may be time duplexed on the low-latency serving channel. In an aspect, the channel structure 210 may be consistent with IEEE 802.11 physical layer requirements. Further, in an aspect, transmissions may be preceded by a listen-before-talk (LBT) period 215 that may be used for determining whether the serving channel (e.g., the communication medium) is free before starting a transmission. The LBT period 215 may also be used to perform a clear channel assessment (CCA) or similar channel sensing mechanisms. A serving AP (e.g., AP2 105-b) may use polling to control access to the serving channel and obtain information from each STA 115 separately. Each STA 115 may be configured to transmit only when the STA 115 is polled by the serving AP2 105-b. The timing diagram 200 may illustrate three stations being polled sequentially.

A polling message 220 may be transmitted by the serving AP2 105-b to an STA 115. The polling message 220 may be transmitted at a time determined by the serving AP2 105-b. For example, the serving AP2 105-b may determine to transmit a polling message at any time when an uplink transmission is not expected. In an aspect, the polling message 220 may be broadcast or otherwise transmitted, and may include a destination address as the address of the polled station. In an aspect, the polling message 220 may include both polling information and data. For example, the polling information may be a flag or other indication in the header that the STA 115 is allowed to transmit following the polling message 220. The polling information may also include a permitted duration in which the STA 115 is allowed to access the channel. The permitted duration may also be selected by the serving AP2 105-b for each polling message 220. For example, the serving AP2 105-b may select a permitted duration based on the transmission pattern of the STA 115, channel conditions, amount of data waiting (e.g., buffered) for transmission by the STA 115, or priority of the STA 115. The polling message 220 may include data or may be an empty frame including only a header but no data. In an example of polling message 220, polling message 220-a may include polling information and data, while polling messages 220-b, 220-c, and 220-d do not include data. The data may include, for example, control data or measurements that may be used to control a robot, drone, or other autonomous or semi-autonomous machine in an industrial setting.

A STA 115 may respond to a polling message 220 by transmitting an acknowledgment (ACK) 225 indicating that the polling message 220 was correctly received or a negative acknowledgment (NAK) indicating that a transmission was incorrectly received 230. In an aspect, the ACK 225 or the NAK 230 may refer to the entire polling message 220. Accordingly, the serving AP2 105-b may determine that the polling information and/or the data are correctly received when an ACK 225 is received. When a NAK 230 is received, the serving AP2 105-b may determine that the corresponding polling message 220 was not correctly received and retransmit the polling message 220. The AP2 105-b may also determine that the polling message 220 was not correctly received when no ACK 225 or NAK 230 is received in response to the polling message 220 within a set time. For example, the polling message 220-c may be incorrectly received, and the third polled station may transmit a NAK 230 (or transmit nothing within the set time). The AP2 105-b may then transmit polling message 220-d, which may be a retransmission of the polling message 220-c. In an aspect, the serving AP2 105-b may transmit a polling message a limited number of times (e.g., 2 or 3) before determining to poll a different STA 115. The serving AP2 105-b may also use a timer to determine when to poll a different STA 115 when no ACK 225 is received. In another aspect, an STA 115 may begin transmitting a data frame 240 without transmitting an ACK 225, in which case the data frame 240 may indicate to the serving AP2 105-b that the polling message 220 was received.

Following an ACK 225 for a polling message 220, the polled STA 115 may transmit a data frame 240. The serving AP2 105-b may monitor for an expected data frame 240 upon receiving an ACK 225. In an aspect, a timer 250 may measure a time period based on the permitted duration in the polling information in which the serving AP2 105-b may expect to receive the data frame 240. The STA 115 may determine what to transmit in the data frame 240. For example, the data frame 240 may carry uplink data and/or signaling from the STA 115. If the serving AP2 105-b successfully receives the data frame 240, the serving AP2 105-b may determine that the remainder of the permitted duration is not needed. The serving AP2 105-b may then cancel the timer 250 and transmit an ACK 260. Cancelling a timer may include deleting, stopping, and/or resetting the timer. For example, for the first polled STA 115, serving AP2 105-b may cancel timer 250-a upon receiving the ACK 260-a. In an aspect, if the data frame 240 includes a more-data indication, the AP2 105-b may determine that the permitted duration is still needed and expect another data frame 240.

As another example, for the second polled STA 115, the serving AP2 105-b may not receive the data frame 240-b within an expected time period or determine that the received data frame 240-b cannot be decoded correctly. Therefore, the serving AP2 105-b may transmit a NAK 270-a and let the timer 250-b continue to run. When the second STA 115 receives the NAK 270-a, the STA 115 may retransmit the data frame 240-b as a retransmission 280-a. If the retransmission 280-a is successfully received, the serving AP may transmit an ACK 260-b and cancel the timer 250-b.

If, on the other hand, the serving AP2 105-b does not successfully receive a retransmission 280-c after a first NAK 270-b, the serving AP2 105-b may transmit another NAK 270-c. The timer 250 may expire if the retransmission is unsuccessful. For example, in the case of the third polled STA 115, the timer 250-c may expire after two NAKs 270-b and 270-c.

In an aspect, a retransmission 280 may use a different modulation and coding scheme (MCS) than the data frame 240. For example, the retransmission 280 may retransmit the data of the data frame 240 with a lower MCS for a more reliable transmission. In an aspect, the number of retransmissions may be limited to help reduce latency, so the lower MCS of the retransmission may provide some additional level of reliability. On the other hand, a lower MCS for the same data may consume more time. Accordingly, by transmitting the data frame 240 with a relatively high MCS followed by a retransmission 280 with a lower MCS only when needed, the STA 115 may transmit uplink data with a low-latency for most data frames while still ensuring high reliability. In an aspect, the MCS for the data frame 240 and the retransmission 280 may be selected such that they meet an expected frame error rate (FER) threshold, which may be low. For example, a target frame error rate of 10⁻⁵ may be expected using a first MCS for the data frame 240 having an expected FER of 10⁻² and a second MCS for the retransmission 280 having an expected FER of 10⁻³. The expected FER for an uplink transmission and the expected error rate for an uplink retransmission may be estimated based on the respective selected MCS. In the above example, the first MCS and the second MCS may be selected such that a product of the estimated frame error rate of the uplink transmission and an estimated frame error rate of the uplink retransmission is less than the target frame error rate. In an aspect, the permitted duration in the polling information and/or the duration of the timer 250 may be based on an MCS used for transmissions.

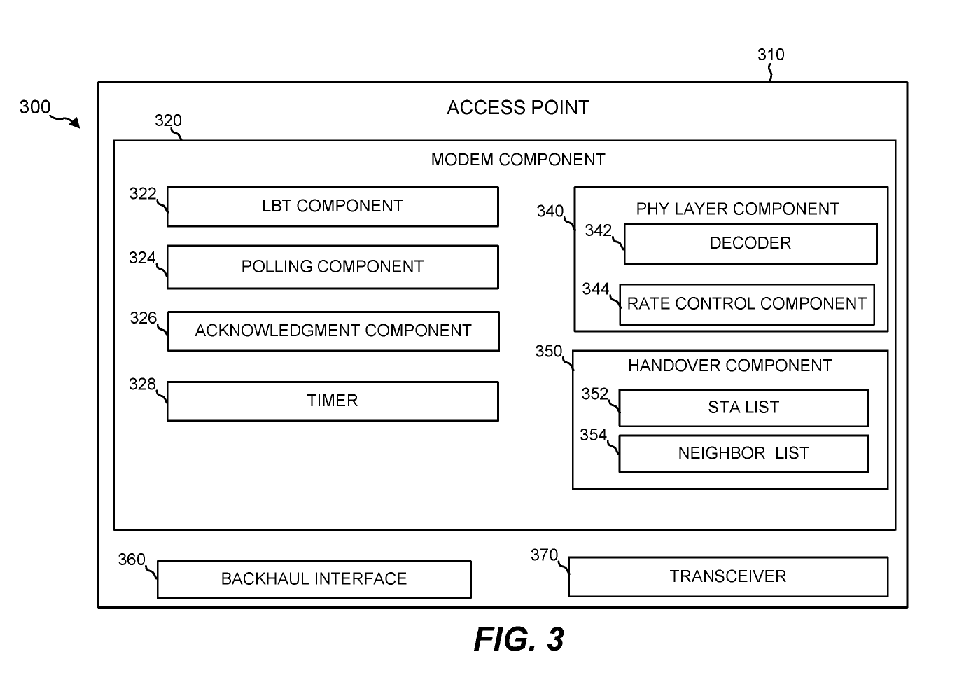

FIG. 3 illustrates a block diagram 300 showing an example access point 310. The access point 310 may be an example of a serving AP2 105-b (FIG. 1) and include a modem component 320, a physical layer (PHY layer) component 340, a handover component 350, a backhaul interface 360, and a transceiver 370.

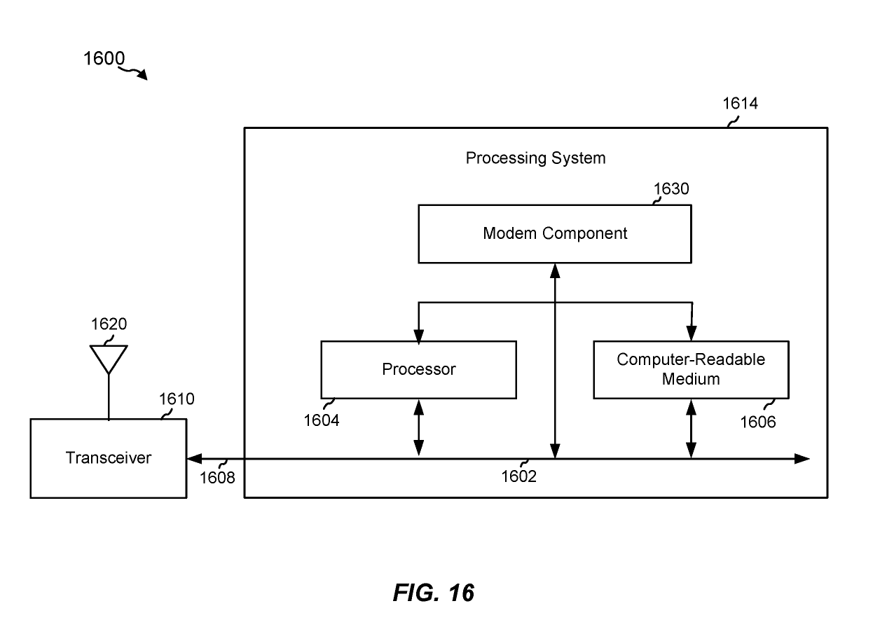

The modem component 320 may be may be or may include one or more processors (e.g., processor 1604 in FIG. 16) configured for performing downlink and uplink transmissions within the channel structure 210 (FIG. 2). The modem component 320, may include a LBT component 322 for determining whether a wireless channel is available, a polling component for indicating whether a STA 115 may transmit in the uplink direction, an acknowledgment component 326 for acknowledging uplink transmissions, and a timer 328 for determining whether a duration of an uplink transmission has expired.

The LBT component 322 may include hardware and/or software code executable by a processor for determining whether a wireless channel is free by using, for example, CCA or other channel sensing mechanism. In an aspect, for example, the LBT component 322 may listen, via the transceiver 370, to the wireless channel for a configured time period to see if any other devices are transmitting on the wireless channel. If the channel is busy, the LBT component 322 may determine a back-off time period to wait before starting a transmission.

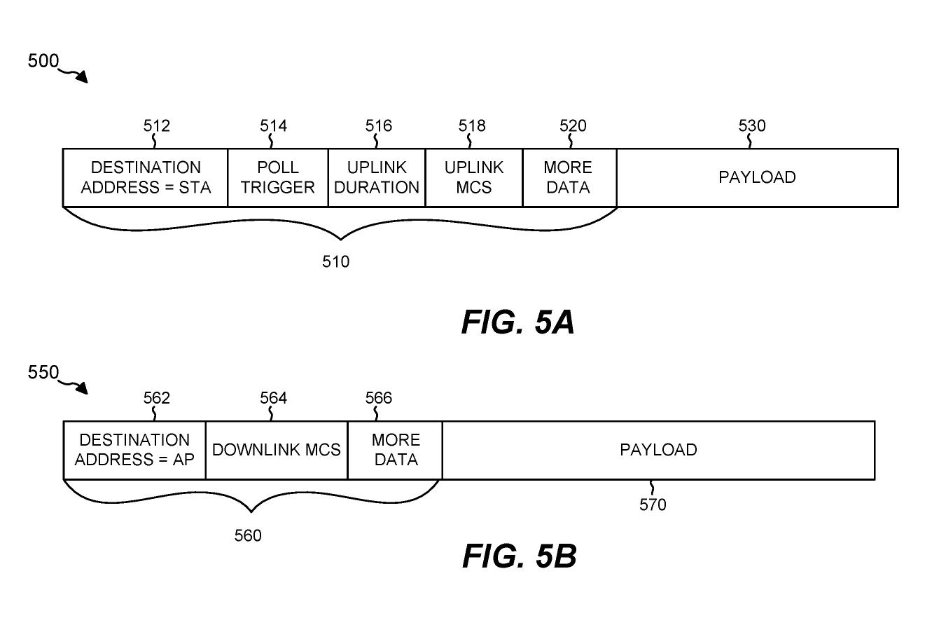

The polling component 324 may include hardware and/or software code executable by a processor for selecting a STA 115 for polling to initiate an uplink transmission. The polling component 324 may determine polling based on latency and throughput needs of the low-latency network. For example, in an aspect, the polling component 324 may use a round-robin approach to periodically poll each STA of a plurality of STAs associated with the access point 310. In another aspect, each STA may be assigned a priority (e.g., based on traffic duty cycle or delay budget) and be polled according to the priority. The polling component 324 may also determine polling based on downlink traffic load. For example, the polling component 324 may determine that a downlink transmission may be sent without polling information when there is a need to quickly send downlink data. In another aspect, the polling component 324 may predict a type of uplink data to be transmitted by a STA 115. For example, the polling component 324 may determine whether a STA 115 is likely to transmit low-latency data or regular data, or determine whether the uplink data is likely to be a management or control message. The prediction may be based on, for example, an uplink transmission pattern associated with the STA 115 and/or an indication (e.g. a more-data field) in a previous uplink transmission. The polling component 324 may indicate polling by setting fields of a header for a downlink frame to create a polling message 220. For example, the polling component 324 may set a poll trigger field 514 (FIG. 5A) and an uplink duration field 516 (FIG. 5A). In an aspect, the polling component 324 may determine the permitted uplink duration based on similar factors as used for selecting an STA. For example, the polling component 324 may determine a permitted uplink duration based on traffic duty cycle, delay budget, configured or historic transmission sizes, and/or the predicted type of data to be transmitted.

The acknowledgment component 326 may include hardware and/or software code executable by a processor for transmitting an acknowledgment when an uplink transmission is successfully received. The acknowledgment component 326 may generate a downlink frame to acknowledge the uplink transmission. The acknowledgment component 326 may transmit the downlink frame via the transceiver 370. The acknowledgment component 326 may also transmit a NAK 270 when an uplink transmission is incorrectly received.

The timer 328 may include hardware and/or software code executable by a processor for determining whether the permitted duration of an uplink transmission has expired. The timer 328 may implement each of the timers 250-a, 250-b, and 250-c in FIG. 2. In an aspect, for example, the timer 328 may include a memory storing a start time, stop time, and/or duration. In an aspect, the duration of the uplink transmission may be variable, and may be determined by the polling component 324 and/or the rate control component 344. In an aspect, the duration for the uplink transmission may be transmitted in the polling information. The duration of timer 328 may be configured to be the same, or slightly longer than the permitted duration for the uplink transmission. When the timer 328 expires, the timer 328 may trigger the polling component 324 to select a new STA 115 to poll.

The PHY layer component 340 may handle physical layer transmission properties such as modulation rate and decoding. In an aspect, the PHY layer component 340 may include a decoder 342 and a rate control component 344. The decoder 342 may receive a signal from the transceiver 370 and determine a MAC protocol data unit (PDU). In an aspect, the decoder 342 may be a soft-decision Viterbi decoder that may be configured to provide a likelihood ratio for a most likely decoding path and also for one or more alternative decoding paths. The decoder 342 may also estimate a signal-to-noise ratio (SNR) for a received transmission.

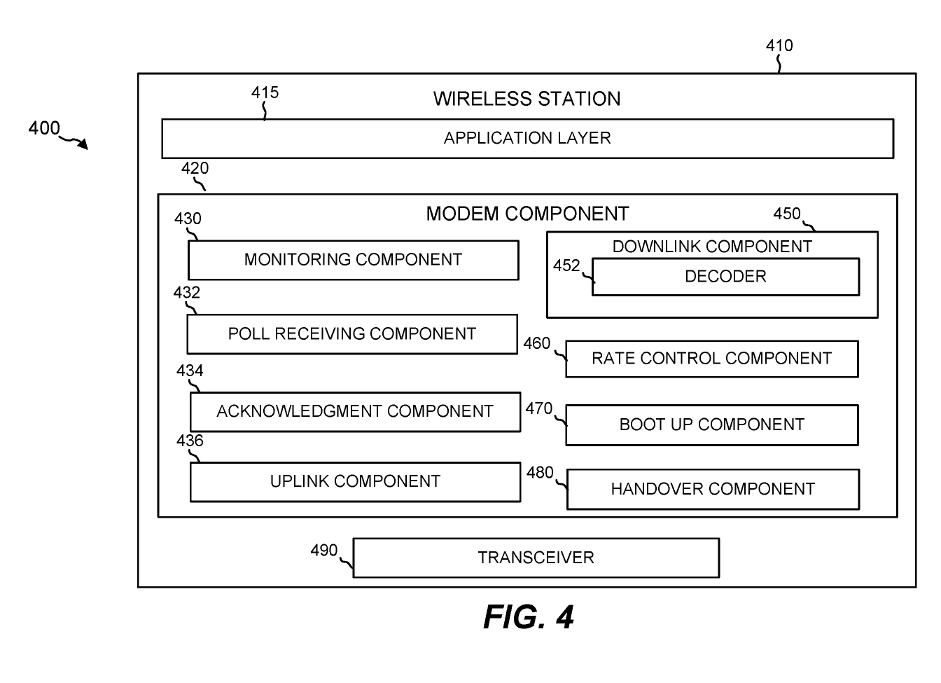

The rate control component 344 may include hardware and/or software code executable by a processor for determining a modulation and coding scheme to use for transmissions. In an aspect, the rate control component 344 may be in communication with a rate control component 460 (FIG. 4) at each STA 115 and signal a modulation and coding scheme and/or receive a signaled modulation and coding scheme. For example, the rate control component 344 may receive signaling indicating a channel quality or requested modulation and coding scheme. The rate control component 344 may also determine a modulation and coding scheme based on a frame error rate target and a channel condition such as SNR.

The handover component 350 may include hardware and/or software code executable by a processor for managing a handover between the access point 310 and a neighbor AP. The handover component 350 may communicate with associated STAs using in-band messages. For example, the handover component 350 may provide handover signaling as downlink data for the polling component 324 to schedule. The handover component 350 may include an STA list 352 for storing information regarding each of the STAs associated with the access point 310. For example, the STA list 352 may receive channel quality measurements from each STA. The handover component 350 may determine whether to hand over an STA based on the channel quality measurements. The handover component 350 may add an STA to the STA list 352 when an STA is handed over to the access point 310 and remove an STA when the AP 310 hands over the STA to a neighbor AP. The handover component 350 may also include a neighbor list 354 for storing information regarding each neighbor AP. For example, the neighbor list 354 may include properties of the neighbor APs such as channels, timing, or other information an STA may use to connect to the neighbor AP.

The access point 310 may also include a backhaul interface 360 for sending and receiving various messages with the neighbor APs. The backhaul interface 360 may be a wired or wireless network interface. The backhaul interface 360 may be used by modem component 320 or one of its sub-components. For example, the handover component 350 may use the backhaul interface 360 to send a transfer request identifying an STA the access point 310 would like to handover and receive a transfer response indicating whether the neighbor AP has accepted a handover of the STA. The backhaul interface 360 may also transmit a handover update message indicating that a STA has acknowledged a handover command and should now be associated with the neighbor AP.

The transceiver 370 may include a radio frequency (RF) transmitter and/or RF receiver for transmitting a scheduled transmission. In an aspect, the transceiver 370 may include one or more transmit chain components and/or antennas. Further, the transceiver 370 may include one or more amplifiers. A transmission power may be adjusted by adjusting the gain applied to the one or more amplifiers. Further, the transceiver 370 may include an RF receiver for receiving RF signals from one or more STAs 115.

FIG. 4 illustrates a block diagram 400 showing an example wireless station 410. The wireless station 410 may be an example of a STA 115 (FIG. 1). The wireless station 410 may include an application layer 415 that may run a low-latency application, a modem component 420 for managing MAC layer processing of wireless communications, and a transceiver 490 for wirelessly transmitting and receiving signals.

The application layer 415 may include hardware and/or software executable by a processor for running one or more applications. In an aspect, the application may be a low-latency application requiring low-latency communications. For example, the application may be a control application for a robot or drone. The application layer 415 may include or be running on a host processor (e.g. processor 1604 in FIG. 16) and communicate with the modem component 420 via a modem driver. In an aspect, the application layer 415 may be configured to minimize latency of communications. In an aspect, for example, the application layer 415 may configure the modem driver to disable interrupt mitigation and frame aggregation. That is, when the application layer 415 has data for transmission, the application layer 415 may immediately forward the data to the modem component 420 without waiting for additional data to aggregate with the data for transmission. The application layer 415 may also receive interrupts from the modem component 420 when each frame is received rather than waiting for aggregation with additional frames. As another example, the application layer 415 may use a raw socket with the modem component 420. The application layer 415 may directly generate MAC layer frames (e.g., MAC service data unit (SDU)) within the application rather than using multi-layer encapsulation to generate MAC layer frames. The MAC layer frame may be the frame 550 in FIG. 5B including the header 560. The application layer 415 may also keep a processor running in performance mode rather than switching to a low-power mode. In an aspect, the application layer 415 may set the modem component 420 to a promiscuous mode to forward all received traffic to the application layer 415 regardless of whether the received traffic is for the wireless station 410. A constant stream of traffic may prevent the processor from entering a low-power mode even when the application traffic has a low duty cycle. In another aspect, the application layer 415 may use a non-infrastructure mode. The non-infrastructure mode may remove beacons and other unnecessary overhead. The non-infrastructure mode may also allow the wireless station 410 to receive frames from an AP that is not associated with the wireless station 410. For example, the modem component 420 may provide received frames to the application layer 415 regardless of a basic service set indicator (BSSI) included in the frame. These features of the application layer 415 may reduce latency between the application layer 415 and the modem component 420.

The modem component 420 may include hardware and/or software executable by a processor (e.g., processor 1604 in FIG. 16) for managing MAC layer processing for wireless communications. In an aspect, the modem component 420 may provide a low-latency time-sharing multi-access MAC layer protocol for communications with an AP 105. For example, the modem component 420 may provide for communication according to the channel structure 210 illustrated in FIG. 2. The modem component 420 may include a monitoring component 430 for determining whether a polling message has been received, a poll receiving component 432 for determining properties for an uplink transmission based on a polling message, an acknowledgment component 434 for acknowledging downlink transmissions, and an uplink component 436 for transmitting an uplink data frame. The modem component 420 may also include a downlink component 450 for receiving downlink transmissions, a rate control component 460 for controlling a modulation rate or MCS, a boot-up component 470 for connecting to a low-latency network, and a handover component 480 for managing mobility between APs.

The monitoring component 430 may include hardware and/or software code executable by a processor for determining whether a polling message has been received. The monitoring component 430 may monitor a wireless channel of the serving AP2 105-b, via the transceiver 490. In particular, the monitoring component 430 may monitor for downlink frames including a header indicating the wireless station 410 as the destination address and having a poll field set. In an aspect, the wireless channel may be asynchronous and the monitoring component 430 may constantly monitor the wireless channel. In another aspect, the monitoring component 430 may be able to determine a time period when a polling message is unlikely to be received. For example, a polling message may be unlikely following a polling message for another station that includes a large downlink transmission or a long duration for an uplink transmission. Accordingly, the monitoring component 430 may indicate that other actions may be performed before the next polling message is expected. For example, the wireless station 410 may perform measurements on another wireless channel to determine a signal strength of a neighbor AP.

The poll receiving component 432 may include hardware and/or software code executable by a processor for determining uplink transmission properties based on a received polling message. In an aspect, the polling message may include an allowed transmission duration and/or a MCS to use for the transmission. The poll receiving component 432 may extract such uplink transmission properties from the received polling message.

The acknowledgment component 434 may include hardware and/or software code executable by a processor for acknowledging downlink frames. For example, the acknowledgment component 434 may acknowledge a polling message 220 by generating an ACK 225 and transmitting the ACK 225 via the transceiver 490. The acknowledgment component 434 may also negatively acknowledge a polling message 220 by generating a NAK 230. The acknowledgment component 434 may also generate an ACK/NAK for downlink frames that do not include polling information.

The uplink component 436 may include hardware and/or software code executable by a processor for determining uplink transmissions of the wireless station 410. For example, the uplink component 436 may include a memory for storing uplink data. The uplink component 440 may receive uplink data from the application layer 415 and temporarily store the uplink data. The uplink component 440 may determine which data to transmit during a time period based on the duration assigned to the wireless station 410 in the polling message 220 and a MCS determined by the rate control component 460. The uplink component 440 may provide the uplink transmission data to the transceiver 490.

The downlink component 450 may include hardware and/or software code executable by a processor for receiving downlink transmissions from an AP 105. The downlink transmissions may be received in a downlink frame, which may be a polling message 220. The downlink component 450 may include a decoder 452. The decoder 452 may first decode a header portion of a downlink frame to determine whether the downlink frame is for the wireless station 410. If a destination address of the downlink frame matches the address of the wireless station 410, the decoder 452 may decode the downlink frame for the wireless station 410.

The rate control component 460 may include hardware and/or software code executable by a processor for determining a modulation rate and/or a MCS for the wireless station 410. In an aspect, the rate control component 460 may be in communication with the rate control component 344. For example, the rate control component 460 may determine a desired MCS for downlink frames based on previously received downlink frames and provide an MCS index to the rate control component 344. The rate control component 460 may also receive MCS information in the polling information to use for an uplink transmission. The rate control component 460 may receive an MCS in the header of a downlink frame to use for decoding the downlink frame. The rate control component 460 may provide the MCS information to the application layer 415 (e.g., via an application programming interface (API)) so that the application layer may generate MAC layer frames.

The boot-up component 470 may include hardware and/or software code executable by a processor for connecting the wireless station 410 to an authentication AP 105-a to join a low-latency network. The boot-up component 470 may perform a random access procedure on a dedicated boot-up channel to connect to the authentication AP 105-a. The boot-up component 470 may then perform an authentication procedure to ensure that the wireless station 410 is allowed to access the low-latency network. The authentication AP 105-a may then hand the wireless station 410 over to a serving AP2 105-b. If wireless station 410 ever becomes disconnected from the serving AP2 105-b, or another serving AP, the boot-up component 470 may reconnect to the low-latency network via the authentication AP 105-a.

The handover component 480 may include hardware and/or software code executable by a processor for managing mobility of the wireless station 410 within a low-latency network. The handover component 480 may be configured to measure the channel quality or signal strength of neighbor APs. The handover component 480 may determine when a handover to one of the neighbor APs should occur, or the handover component 480 may report the channel quality to the current serving AP2 105-b. In an aspect, the handover component 480 may include a dedicated transceiver for performing measurements. The dedicated transceiver may be tuned to wireless channels used by neighbor APs without interrupting communications between the wireless station 410 and the serving AP2 105-b via the transceiver 490.

The transceiver 490 may include an RF transmitter for transmitting a scheduled transmission. In an aspect, the transceiver 370 may include one or more transmit chain components and/or antennas. Further, the transceiver 370 may include one or more amplifiers. A transmission power may be adjusted by adjusting the gain applied to the one or more amplifiers. Further, the transceiver 490 may include an RF receiver for receiving RF signals from one or more APs 105.

FIG. 5A shows a diagram illustrating an example downlink frame 500. The example downlink frame 500 may be an example of a polling message 220 (FIG. 2). The downlink frame 500 may include a header 510 and a payload 530. In an aspect, a polling message 220 may include a header 510 but may not include a payload 530. The header 510 may include a destination address 512, a poll trigger field 514, an uplink duration field 516, an uplink MCS field 518, and a more data field 520. The destination address 512 may be the address of the wireless station 410 or may indicate that the downlink frame 500 is for a different station. The poll trigger field 514 may be a flag or single bit indicating whether the wireless station 410 may send an uplink transmission following the downlink frame 500 (e.g., after being polled). The uplink duration field 516 may indicate a permitted length of an uplink frame to be transmitted by the wireless station 410. In an aspect, the uplink duration field 516 may be measured in time or bits. For example, when the serving AP2 105-b determines a MCS for the uplink transmission, the uplink duration may indicate a number of bits that may be transmitted and/or retransmitted using the MCS. If the wireless station 410 determines the MCS, the uplink duration may indicate an amount of time allowed for the transmission. The uplink MCS field 518 may indicate a MCS to be used for the uplink frame. The uplink MCS field 518 may include, for example, an index into a table with MCS properties. The more data field 520 may indicate whether the serving AP2 105-b will transmit another downlink frame following the downlink frame 500. For example, the more data field 520 may indicate that the AP2 105-b may transmit signaling in addition to data.

FIG. 5B shows a diagram illustrating an example uplink frame 550. The uplink frame 550 may include a header 560 and payload 570. The header 560 may include a destination address field 562, a downlink MCS field 564, and a more data field 566. The destination address field 562 may indicate the serving AP2 105-b because the wireless station 410 may only be allowed to communicate with the serving AP2 105-b on the serving wireless channel. The downlink MCS field 564 may indicate a MCS to be used for downlink transmissions. The downlink MCS may indicate an MCS that may achieve a target FER as determined by the rate control component 460. The more data field 566 may indicate whether the wireless station 410 has addition data to transmit. In an aspect, the wireless station 410 may be allowed to transmit the additional data if it receives an ACK 260 (see e.g., FIG. 2) for the uplink frame 550. The additional data may include, for example, signaling data such as channel measurements. In another aspect, the more data field 566 may indicate that the wireless station 410 should be polled again to allow transmission of the additional data.

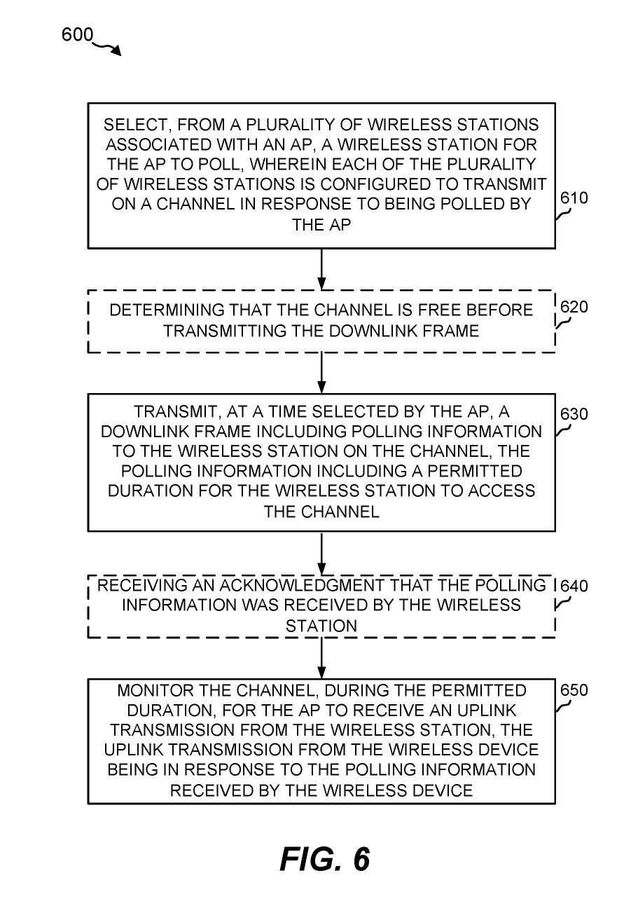

FIG. 6 shows a flow chart illustrating an example of aspects of a method 600 of providing low-latency asynchronous time-sharing communications. The method 600 may be performed by an access point such as a serving AP2 105-b or access point 310.

At block 610, the method 600 may include selecting, from a plurality of wireless stations associated with an access point (AP), a wireless station for the AP to poll, wherein each of the plurality of wireless stations is configured to transmit on a channel in response to being polled by the AP. In an aspect, for example, the polling component 324 may select, from a plurality of wireless stations associated with the AP, the wireless station for the AP to poll. In an aspect, the plurality of wireless stations may be configured to transmit on the channel only in response to being polled by the AP.

At block 620, the method 600 may optionally include determining that the channel is free before transmitting a downlink frame. In an aspect, for example, the LBT component 322 may determine whether the channel is free before transmitting a downlink frame.

At block 630, the method 600 may include transmitting, at a time selected by the AP, the downlink frame including polling information to the wireless station on the channel, the polling information including a permitted duration for the wireless station to access the channel. In an aspect, for example, the transceiver 370 may transmit the downlink frame including polling information to the wireless station on the channel at a time selected by the AP. In an aspect, because the AP may select any time for transmitting the polling information, the polling may be aperiodic. For example, the time between a first polling message and a second polling message may be different than a time between the second polling message and a third polling message. The permitted duration may also be selected by the polling component 324. Other implementations may use periodic polling instead of aperiodic polling, or may switch between periodic portions of time and aperiodic portions of time.

At block 640, the method 600 may optionally include receiving an acknowledgment that the polling information was received by the wireless station. In an aspect, for example, the acknowledgment component 326 may receive an acknowledgment (e.g., ACK 225-a in FIG. 2) that the polling information was received by the wireless station.

At block 650, the method 600 may include monitoring, during the permitted duration, for the AP to receive an uplink transmission from the wireless station on the channel, the uplink transmission from the wireless station being in response to the polling information received by the wireless station. In an aspect, for example, the transceiver 370 may monitor the channel during the permitted duration as measured by the timer 328. The timer 328 may start when an ACK 225 is received from the wireless station in response to a polling message 220.

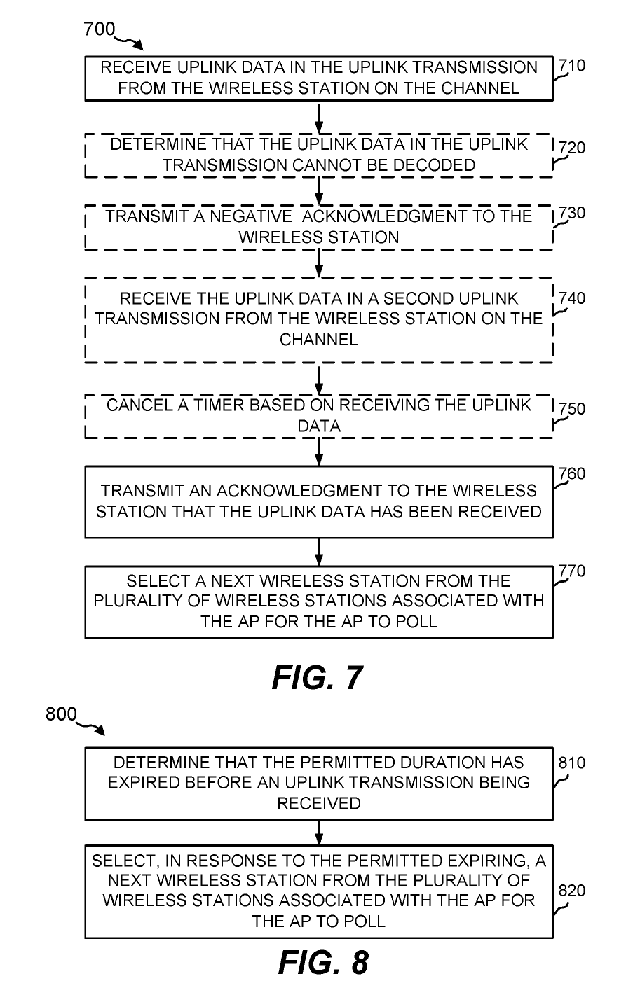

FIG. 7 shows a flow chart illustrating an example of aspects of a method 700 of providing low-latency asynchronous time-sharing communications. The method 700 may be performed by an access point such as a serving AP2 105-b or access point 310. The method 700 may follow the method 600 and may be a continuation of the method 600.

At block 710, the method 700 may include receiving uplink data in the uplink transmission from the wireless station on the channel. In an aspect, for example, transceiver 370 may receive uplink data in the uplink transmission from the wireless station on the channel.

At block 720, the method 700 may optionally include determining that the uplink data in the uplink transmission cannot be decoded. In an aspect, for example, the decoder 342 may determine that the uplink data in the uplink transmission cannot be decoded. The decoder 342 may also determine that the uplink data cannot be decoded when no uplink transmission is received during an expected time period for the uplink transmission.

At block 730, the method 700 may optionally include transmitting a negative acknowledgment to the wireless station. In an aspect, for example, the acknowledgment component 326 may transmit a negative acknowledgment (e.g., NAK 270-a in FIG. 2) to the wireless station.

At block 740, the method 700 may optionally include receiving the uplink data in a second uplink transmission from the wireless station on the channel. In an aspect, for example, the transceiver 370 may receive the uplink data in a second uplink transmission from the wireless station on the channel.

At block 750, the method 700 may optionally include cancelling the timer based on receiving the uplink data. In an aspect, for example, the timer 328 may be cancelled by the decoder 342 or acknowledgment component 326 based on receiving the uplink data. Cancelling the timer may include resetting the timer to a default value (e.g., 0), disabling the timer, or taking no action if the timer expires.

At block 760, the method 700 may include transmitting an acknowledgment to the wireless station that the uplink data has been received. In an aspect, for example, the acknowledgment component 326 may transmit an acknowledgment to the wireless station that the uplink data has been received.

At block 770, the method 700 may include selecting a next wireless station from the plurality of wireless stations associated with the AP for the AP to poll before the end of the permitted duration. In an aspect, for example, the polling component 324 may select a next wireless station from the plurality of wireless stations associated with the AP for the AP to poll before the end of the permitted duration. Accordingly, a remaining portion of the permitted duration may be used for polling the next wireless station.

FIG. 8 shows a flow chart illustrating an example of aspects of a method 800 of providing low-latency asynchronous time-sharing communications. The method 800 may be performed by an access point such as a serving AP2 105-b or access point 310. The method 800 may follow the method 600 and may be a continuation of the method 600. The method 800 may also follow block 730 of the method 700.

At block 810, the method 800 may include determining that the permitted duration has expired before an uplink transmission being received. In an aspect, for example, the timer 328 may determine and/or indicate that the permitted duration has expired before the uplink transmission being received.

At block 820, the method 800 may include selecting, in response to the permitted duration expiring, a next wireless station from the plurality of wireless stations associated with the AP for the AP to poll. In an aspect, for example, the polling component 324 may select, in response to the permitted duration expiring, a next wireless station from the plurality of wireless stations associated with the AP for the AP to poll.

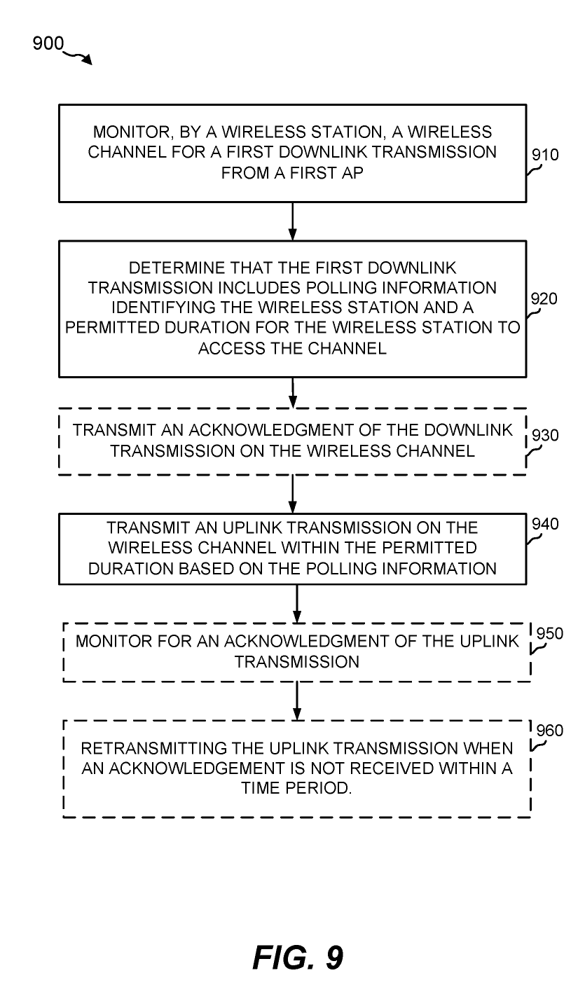

FIG. 9 shows a flow chart illustrating an example of aspects of a method 900 of providing low-latency synchronous communications. The method 900 may be performed by a station such as a STA 115 or wireless station 410.

At block 910, the method 900 may include monitoring, by a wireless station, a wireless channel for a first downlink transmission from a first access point (AP). In an aspect, for example, the monitoring component 430 may monitor the wireless channel for a first downlink transmission from the first AP.

At block 920, the method 900 may include determining that the downlink transmission includes polling information identifying the wireless station. In an aspect, for example, the poll receiving component 432 may determine that the downlink transmission includes polling information identifying the wireless station.

At block 930, the method 900 may optionally include transmitting an acknowledgment of the downlink transmission on the wireless channel. In an aspect, for example, the acknowledgment component 434 may transmit the acknowledgment (e.g., ACK 225-a in FIG. 2) of the downlink transmission on the wireless channel.

At block 940, the method 900 may include transmitting an uplink transmission on the wireless channel within the permitted duration based on the polling information. In an aspect, for example, the uplink component 436 may transmit an uplink transmission on the wireless channel based on the polling information.

At block 950, the method 900 may optionally include monitoring for an acknowledgment of the uplink transmission. In an aspect, for example, the monitoring component 430 may monitor for an acknowledgment of the uplink transmission. The monitoring component 430 may determine that the uplink transmission was received if an ACK 260 is received. If no ACK 260 is received, or a NAK 270 is received, the monitoring component 430 may determine that the uplink transmission was not correctly received.

At block 960, the method 900 may optionally include retransmitting the uplink transmission when an acknowledgement is not received within a time period. In an aspect, for example, the uplink component 436 may retransmit the uplink transmission when an acknowledgment is not received within a time period. Referring back to FIG. 2, for example, the uplink component 436 may retransmit data frame 240-b as retransmission 280 when an acknowledgment is not received within a time period or a NAK 270-a is received. In an aspect, when retransmitting the uplink transmission the uplink component 436 may use a lower modulation and coding scheme to improve reliability.

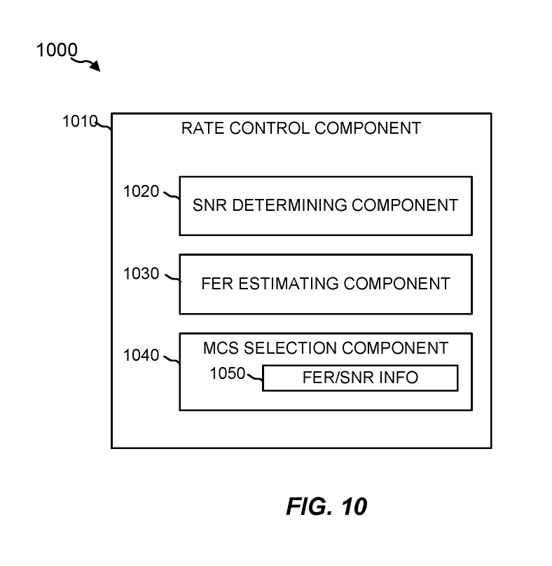

FIG. 10 shows a block diagram 1000 illustrating an example of a rate control component 1010. The rate control component 1010 may correspond to either the rate control component 344 (FIG. 3) or the rate control component 460 (FIG. 4). The rate control component 1010 may be configured to determine a modulation rate or a modulation and coding scheme (MCS) for a transmission. The rate control component 1010 may include an SNR determining component 1020, a FER estimating component 1030, and an MCS selection component 1040.

The SNR determining component 1020 may be configured to determine a signal-to-noise ratio of a received signal. In an aspect, for example, the SNR determining component 1020 may perform measurements of a received signal, or may acquire measurements from a decoder 342, 452.

The FER estimating component 1030 may be configured to estimate a frame error rate (FER) based on a received frame. In an aspect, the FER estimating component 1030 may estimate the FER based on a single frame. In a low-latency application, a desired FER may be extremely low (e.g., 10⁻⁴). Accordingly, determining a FER based on a number of actually erroneously received frames may take a relatively long time because the erroneously received frames may be uncommon. The FER estimating component 1030 may estimate a FER for a single frame using likelihood ratios provided by a decoder. For example, a soft-decision Viterbi decoder may provide a likelihood ratio of a most likely path, which may be chosen as the decoded frame. The soft-decision Viterbi decoder may also provide a likelihood ratio of one or more alternative paths that were not chosen as the decoded frame. The FER estimating component 1030 may determine a ratio of the likelihood ratio of the chosen path to the sum of likelihood ratios of other likely paths for the frame. For example, the FER may be estimated according to the following equation:

$$FER = Pr \{ C \neq \hat{c} \vert \vec{y} \} \approx 1 - \frac{Pr \{ \vec{y} \vert decoded path \}}{{\sum }_{i = 1}^{k} Pr \{ \vec{y} \vert ith likely path \}}$$

C may be the decoded code word, and ĉ may be the transmitted code word. \vec{y} may be a vector of the received signal for the decoded path. Pr{\vec{y}|path i} may be a function of a likelihood ratio of a decoded path, i. For example, for a Gaussian white noise channel,

$$Pr \{ \vec{y} \vert path i \} ∝ exp \{ - \frac{{E}_{s}}{{N}_{0}} {d}_{i}^{2} \} . \frac{{E}_{s}}{{N}_{0}}$$

may be a signal to noise measurement for the channel and dᵢ may be the Hamming distance between the received signal and its corresponding constellation point.

The FER estimating component 1030 may update historic FER and SNR information 1050 based on the estimated FER for each frame. For example, the FER estimating component 1030 may recalculate an FER/SNR curve based on the estimated FER.

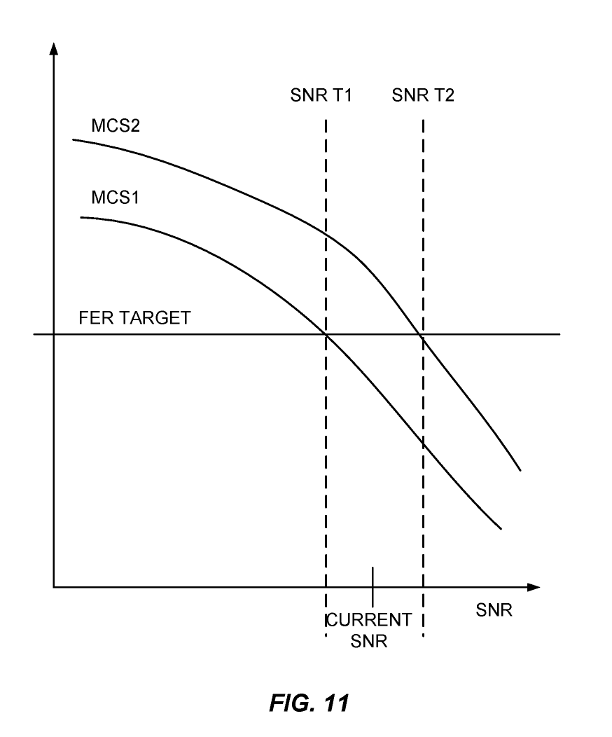

The MCS selection component 1040 may select a modulation rate or MCS based on historical FER and SNR information 1050 for each of a plurality of modulation and coding schemes. In aspect, the MCS selection component 1040 may store FER and SNR information 1050 for each MCS. FIG. 11 illustrates example FER/SNR curves. Generally, as SNR increases, the FER will decrease. The MCS selection component 1040 may determine an SNR threshold (e.g., SNR T1 and STR T2) required to meet a FER target for each MCS. The MCS selection component 1040 may then compare each SNR threshold to the current SNR measured by SNR determining component 1020. The MCS selection component 1040 may select the highest MCS where the SNR threshold is less than the current SNR.

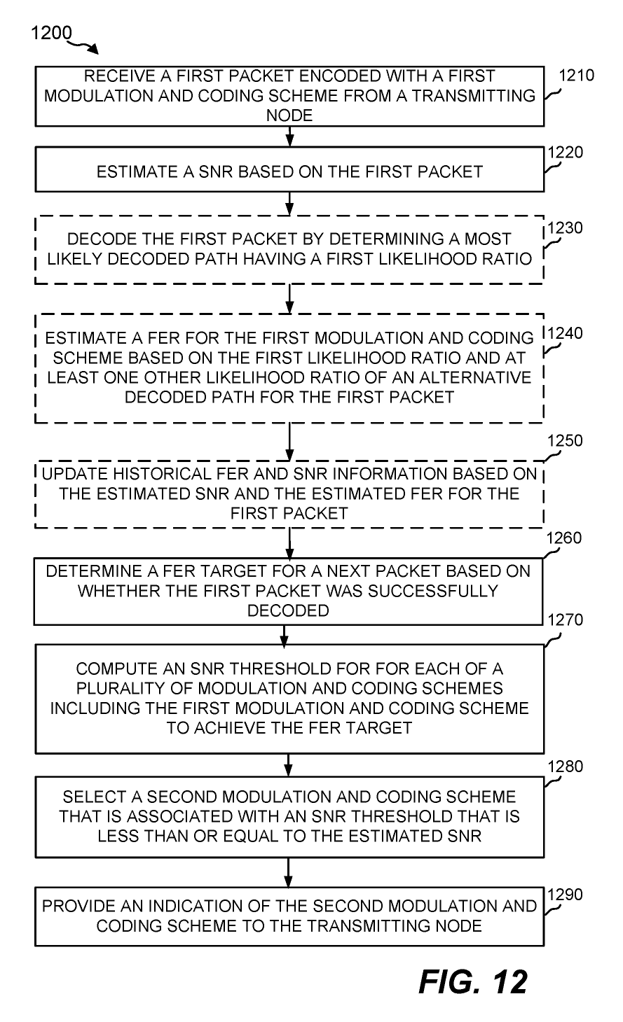

FIG. 12 shows a flow chart illustrating an example of aspects of a method 1200 of determining a modulation and coding scheme (MCS). The method 1200 may be performed by a rate control component 1010, which may be located in, for example, an access point 310 or wireless station 410.

At block 1210, the method 1200 may include receiving a first packet encoded with a first modulation and coding scheme from a transmitting node. In an aspect, for example, the rate control component 1010 may receive the first packet encoded with a first modulation and coding scheme from a transmitting node via a transceiver.

At block 1220, the method 1200 may include estimating a signal-to-noise ratio (SNR) based on the first packet. In an aspect, for example, the decoder 342 may estimate the SNR based on the first packet.

At block 1230, the method 1200 may optionally include decoding the first packet by determining a most likely decoded path having a first likelihood ratio. In an aspect, for example, a decoder 342, 452 may decode the first packet by determining the most likely decoded path having the first likelihood ratio. In an aspect, the decoding may be unsuccessful. For example, a cyclic redundancy check (CRC) of the packet may not pass.

At block 1240, the method 1200 may optionally include estimating a FER for the first modulation and coding scheme based on the first likelihood ratio and at least one other likelihood ratio of an alternative decoded path for the first packet. In an aspect, for example, the FER estimating component 1030 may estimate the FER for the first modulation and coding scheme based on the first likelihood ratio and at least one other likelihood ratio of an alternative decoded path for the first packet.

At block 1250, the method 1200 may optionally include updating historical FER and SNR information based on the estimated SNR and the estimated FER for the first packet. In an aspect, for example, the FER estimating component 1030 may update historical FER and SNR information 1050 based on the estimated SNR and the estimated FER for the first packet. For example, the FER estimating component 1030 may update historical FER and SNR information 1050 for the first modulation and coding scheme.

At block 1260, the method 1200 may include determining a FER target for a next packet based on whether the first packet was successfully decoded. In an aspect, for example, the rate control component 1010, the acknowledgment component 326, or the acknowledgment component 434 may determine the FER target. In an aspect, the FER target may be determined by adjusting a current FER target (e.g. the FER target used to determine the first modulation and coding scheme). For example, the FER target for the next packet may be determined by decreasing the current FER target when the first packet is decoded incorrectly. Accordingly, a FER target for a retransmission may have a lower FER target. Therefore, the FER target for a retransmission may be an estimated frame error rate for the uplink transmission that is different than an FER target for an original uplink transmission. If the first packet is decoded correctly, the FER target may remain the same, or may be reset to a default level in the case that the first packet was a retransmission.

At block 1270, the method 1200 may include computing an SNR threshold for each of a plurality of modulation and coding schemes including the first modulation and coding scheme to achieve the FER target. In an aspect, for example, the MCS selection component 1040 may compute the SNR threshold for each of a plurality of modulation and coding schemes including the first modulation and coding scheme to achieve the FER. The MCS selection component 1040 may compute the SNR threshold for each of a plurality of modulation and coding schemes to achieve the FER based on the historical FER and SNR information 1050. In an aspect, the historical FER and SNR information 1050 for the first modulation and coding scheme may be the updated historical FER and SNR information.

At block 1280, the method 1200 may include selecting a second modulation and coding scheme that is associated with a SNR threshold that is less than or equal to the estimated SNR, In an aspect, for example, the MCS selection component 1040 may select the second modulation and coding scheme that is associated with the SNR threshold that is less than or equal to the estimated SNR.

At block 1290, the method 1200 may include providing an indication of the second modulation and coding scheme to the transmitting node. In an aspect, for example, a transceiver 370, 490 may provide the second modulation and coding scheme to the transmitting node. In an aspect, the second modulation and coding scheme may be provided within a scheduled in-band transmission.

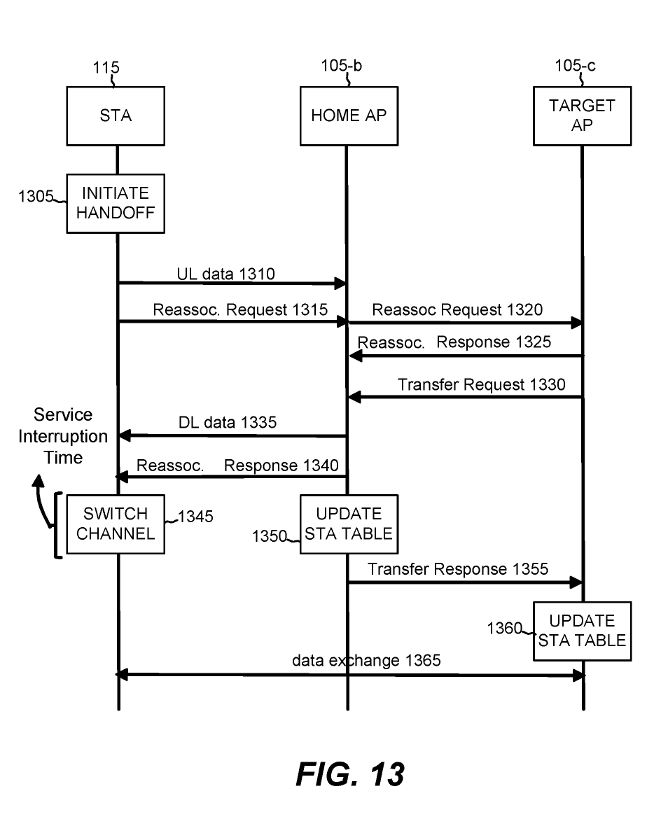

FIG. 13 shows a message diagram illustrating an example of a method 1300 for performing handover of a station. For example, a home AP (e.g., AP2 105-b) may handover a STA 115 to a target AP (e.g., AP3 105-c). At block 1305, the STA 115 may initiate a handoff based on signal strength measurements for the AP2 105-b and AP3 105-b. For example, the STA 115 may determine that the signal strength of target AP3 105-b is stronger than the signal strength of home AP2 105-b. At message 1310, the STA may send uplink data to the home AP2 105-b. At message 1315, the STA 115 may send a reassociation request indicating the target AP3 105-b to the home AP2 105-b. The reassociation request may be included in the uplink data. At message 1320, the home AP2 105-b may forward the reassociation request to the target AP3 105-b. At message 1325, the target AP3 105-b may respond with a reassociation response indicating that the request has been accepted. At message 1330 the target AP3 105-b may send a transfer request to the home AP2 105-b identifying the STA 115 to transfer. At message 1335, the home AP2 105-b may transmit downlink data to the STA 115. The downlink data may include a reassociation response 1340 indicating that the STA 115 should switch to a channel of the target AP3 105-b. In an aspect, the reassociation response 1340 may command the STA 115 to switch to the channel of the target AP3 105-b. At block 1345 the STA 115 may switch channels. The STA 115 may experience a service interruption while actually switching channels. At block 1350, the home AP2 105-b may update an STA table to remove the STA 115 from the list of associated STAs. At message 1355, the home AP2 105-b may send a transfer response to the target AP3 105-b indicating that the STA 115 has been handed over. At block 1360, the target AP3 105-b may update its STA table to include the STA 115 on the list of associated APs. At message 1365 data exchange may occur between the STA 115 and the target AP3 105-b based on scheduling by the AP3 105-b.

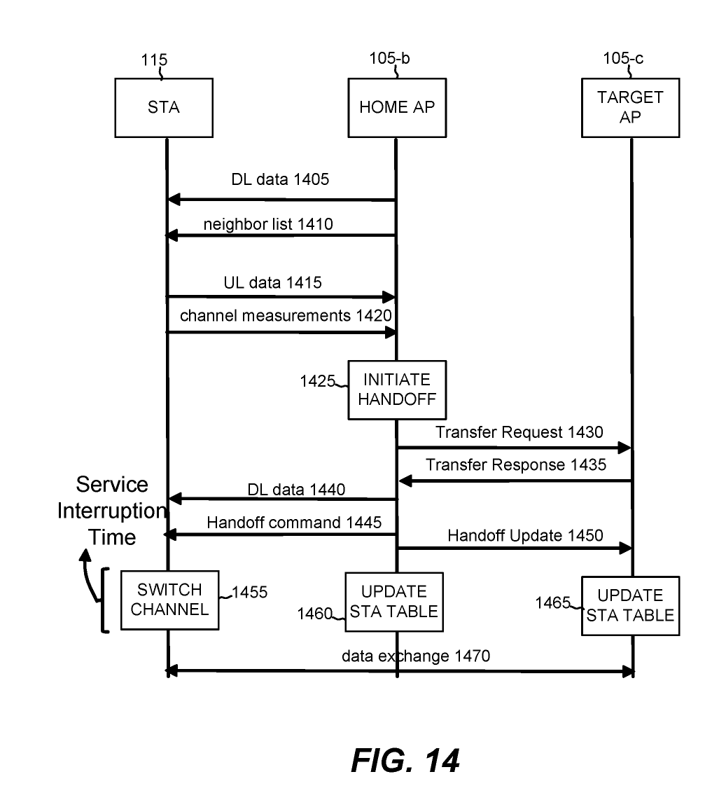

FIG. 14 shows a message diagram illustrating an example of a method 1400 for performing handover of a station. For example, a home AP (e.g., AP2 105-b) may handover a STA 115 to a target AP (e.g., AP3 105-b). At message 1405, the home AP2 105-b may transmit downlink data to the STA 115. The downlink data may include a neighbor list 1410 indicating one or more neighbor APs that the STA 115 should monitor. At message 1415, the STA 115 may transmit uplink data to the home AP2 105-b. The uplink data may include channel measurements 1420 indicating, for example, signal strengths of the home AP 105-b and a neighbor AP3 105-b. At block 1425 the home AP2 105-b may initiate a handoff from the home AP2 105-b to the target AP3 105-b. The home AP2 105-b may determine to initiate the handoff based on the received channel measurements. At message 1430, the home AP2 105-b may send a transfer request indicating the STA 115 that the home AP2 105-b would like to transfer. At message 1435, the target AP3 105-b may send a transfer response indicating that the target AP3 105-b has accepted the handover. At message 1440, the home AP2 105-b may transmit downlink data to the STA 115. The downlink data may include a handoff command 1445 indicating that the STA 115 should switch to the channel of the target AP3 105-b. At message 1450, the home AP2 105-b may send a handoff update to the target AP3 105-b indicating that the handover has been performed. At block 1455, the STA 115 may experience service interruption while switching channels. At block 1460, the home AP2 105-b may update the STA table to remove the STA 115 from the list of STAs associated with the home AP2 105-b. At block 1465, the target AP3 105-b may update its STA table to add the STA 115 to the list of STAs associated with the target AP3 105-b. In an aspect, blocks 1455, 1460, and 1465 may occur at substantially the same time such that STA 115 experiences little or no delay in scheduling. For example, the STA 115 may be scheduled in the next traffic block after switching channels. At message 1470, data exchange may occur between the target AP3 105-b and the STA 115 based on scheduling by the target AP3 105-b.

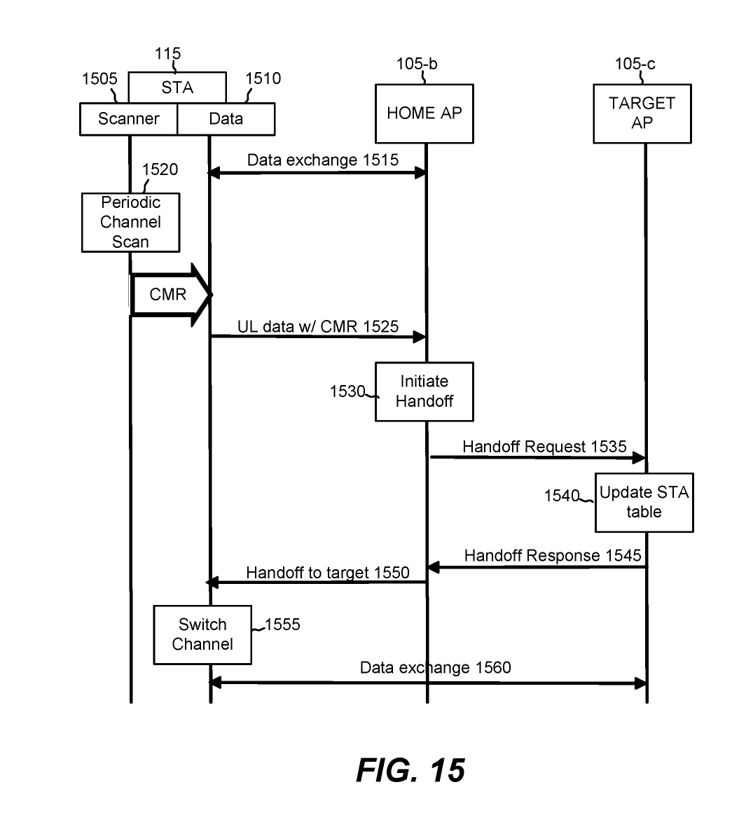

FIG. 15 shows a message diagram illustrating an example of a method 1500 for performing handover of a station. For example, a home AP (e.g., AP 105-b) may handover a STA 115 to a target AP (e.g., AP 105-c). In an aspect, the STA 115 may include at least two transceivers capable of receiving signals on two different channels. One of the transceivers may be used as a dedicated scanner 1505. Another transceiver may be used as a dedicated data transceiver 1510. At message 1515, the STA 115 may exchange data with the home AP 105-b using the data transceiver 1510. At block 1520, the dedicated scanner 1505 may perform a period channel scan. For example, the dedicated scanner 1505 may scan a channel of each neighbor AP. The dedicated scanner may pass a channel measurement report (CMR) to the data transceiver 1510. At message 1525, the data transceiver 1510 may transmit uplink data including the CMR to the home AP 105-b. At block 1530, the home AP 105-b may initiate a handoff from the home AP 105-b to the target AP 105-c based on the CMR. At message 1535, the home AP 105-b may send a handoff request to the target AP 105-c requesting handoff of the STA 115. At block 1540, the target AP 105-c may update its STA table to add the STA 115 to the list of STAs associated with the target AP 105-c. At message 1545, the target AP 105-c may send a handoff response indicating that the target AP 105-c has accepted the handoff. At message 1550, the home AP 105-b may transmit a handoff command to the STA 115 indicating the target AP 105-c. At block 1555, the data transceiver 1510 may switch to the channel of the target AP 105-c. At message 1560, the target AP 105-c may exchange data with the data transceiver 1510 based on scheduling by the target AP 105-c.

FIG. 16 shows a block diagram 1600 illustrating an example of a processing system 1614 configured for providing low-latency communications. In one aspect, the processing system 1614 may implement the access point 310 (FIG. 3). In another aspect, the processing system 1614 may implement the wireless station 410 (FIG. 4). The processing system 1614 may be implemented with a bus architecture, represented generally by the bus 1602. The bus 1602 may include any number of interconnecting buses and bridges depending on the specific application of the processing system 1614 and the overall design constraints. The bus 1602 links together various circuits including one or more processors and/or hardware modules, represented by the processor 1604, the modem component 1630 and the computer-readable medium/memory 1606. In an aspect, the processor 1604 may be a host processor for the wireless station 410 and execute applications for the application layer 415. The bus 1602 may also link various other circuits such as timing sources, peripherals, voltage regulators, and power management circuits, which are well known in the art, and therefore, will not be described any further.

The processing system 1614 may be coupled to a transceiver 1610 via an interface 1608. The transceiver 1610 is coupled to one or more antennas 1620. The transceiver 1610 may provide a means for communicating with various other apparatus or devices over a transmission medium. The transceiver 1610 may receive a signal from the one or more antennas 1620, may extract information from the received signal, and may provide the extracted information to the processing system 1614, specifically the processor 1604. In addition, the transceiver 1610 may receive information from the processing system 1614, and based on the received information, may generate a signal to be applied to the one or more antennas 1620. In an aspect, the transceiver 1610 may be an example of the transceiver 370 (FIG. 3) or the transceiver 490 (FIG. 4). The processing system 1614 includes the processor 1604 coupled to the computer-readable medium/memory 1606, and/or to the modem component 1630, which may be an example of the modem component 320 (FIG. 3) or the modem component 420 (FIG. 4). In an aspect, the modem component 1630 includes a separate processor (not shown) that implements any of the subcomponents of the modem component 320 (FIG. 3) or the modem component 420 (FIG. 4). The processor 1604 is responsible for general processing, including the execution of software stored on the computer-readable medium/memory 1606. The software, when executed by the processor 1604, causes the processing system 1614 to perform the various functions described in the disclosure for communicating in a low-latency WLAN network. In an aspect, the modem component 1630 and any of the subcomponents of the modem component 320 (FIG. 3) or the modem component 420 (FIG. 4) may be implemented by the processor 1604 executing software. For example, the software may cause the processing system 1614 to communicate as either an AP or STA as described above. The processing system 1614 may, for example, generate polling messages, acknowledgments, data frames or other transmissions. The processing system 1614 may also monitor received signals for polling messages, downlink or uplink frames, and/or acknowledgments. For example, when the processing system 1614 is acting as an AP, the processor 1604 executing software stored in the computer-readable medium/memory 1606 may select a wireless station for the AP to poll and generate, at a time selected by the AP, a downlink frame including polling information to the wireless station on the channel. The transceiver 1610 may transmit the downlink frame. The processor 1604 executing software stored in the computer-readable medium/memory 1606 may then monitor the channel, during the permitted duration, for the AP to receive an uplink transmission from the wireless station via the transceiver 1610. The computer-readable medium/memory 1606 may also be used for storing data that is manipulated by the processor 1604 when executing software. The modem component 1630 may be a software module running in the processor 1604, resident/stored in the computer readable medium/memory 1606, a hardware module coupled to the processor 1604, or some combination thereof. In some instances, the processor 1604 and the computer readable medium/memory 1606 may be used to perform functions, operations, or features described herein with respect to one or more of the components of the modem component.

For example, when the processing system 1614 is acting as an AP, the processor 1604 executing software stored in the computer-readable medium/memory 1606 may select a wireless station for the AP to poll and generate, at a time selected by the AP, a downlink frame including polling information to the wireless station on the channel. The transceiver 1610 may transmit the downlink frame. The processor 1604 executing software stored in the computer-readable medium/memory 1606 may then monitor the channel, during the permitted duration, for the AP to receive an uplink transmission from the wireless station via the transceiver 1610.

As another example, when the processing system 1614 is acting as an STA, the processor 1604 executing software stored in the computer-readable medium/memory 1606 may monitor a wireless channel for a first downlink transmission from a first AP. The processor 1604 executing software stored in the computer-readable medium/memory 1606 may determine that the first downlink transmission includes polling information identifying the wireless station and a permitted duration for the wireless station to access the channel. The transceiver 1610 may transmit an uplink transmission on the wireless channel within the permitted duration based on the polling information.

The apparatus and methods have been described in the detailed description and illustrated in the accompanying drawings by various elements comprising blocks, modules, components, circuits, steps, processes, algorithms, and the like. These elements, or any portion thereof, either alone or in combinations with other elements and/or functions, may be implemented using electronic hardware, computer software, or any combination thereof. Whether such elements are implemented as hardware or software depends upon the particular application and design constraints imposed on the overall system. In an aspect, the term “component” as used herein may be one of the parts that make up a system and may be divided into other components.

By way of example, an element, or any portion of an element, or any combination of elements may be implemented with a “processing system” that includes one or more processors. A processor may include a general purpose processor, a digital signal processor (DSP), an application specific integrated circuit (ASIC), a field programmable gate array (FPGA) or other programmable logic component, discrete gate or transistor logic, discrete hardware components, or any combination thereof, or any other suitable component designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a plurality of microprocessors, one or more microprocessors in conjunction with a DSP, or any other such configuration.

One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A non-transitory computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), static RAM (SRAM), dynamic RAM (DRAM), synchronous dynamic RAM (SDRAM); double date rate RAM (DDRAM), read only memory (ROM), programmable ROM (PROM), erasable PROM (EPROM), electrically erasable PROM (EEPROM), a general register, or any other suitable non-transitory medium for storing software.

The various interconnections within a processing system may be shown as buses or as single signal lines. Each of the buses may alternatively be a single signal line, and each of the single signal lines may alternatively be buses, and a single line or bus might represent any one or more of a myriad of physical or logical mechanisms for communication between elements. Any of the signals provided over various buses described herein may be time-multiplexed with other signals and provided over one or more common buses.

The various aspects of this disclosure are provided to enable one of ordinary skill in the art to practice the present invention. Various modifications to examples of implementations presented throughout this disclosure will be readily apparent to those skilled in the art, and the concepts disclosed herein may be extended to other magnetic storage devices. Thus, the claims are not intended to be limited to the various aspects of this disclosure, but are to be accorded the full scope consistent with the language of the claims. All structural and functional equivalents to the various components of the examples of implementations described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112 (f), unless the element is expressly recited using the phrase “means for” or, in the case of a method claim, the element is recited using the phrase “step for.”

What is claimed is:

1. A method for wireless communications, comprising:
selecting, from a plurality of wireless stations associated with an access point (AP), a wireless station for the AP to poll, wherein each of the plurality of wireless stations is configured to transmit on a channel in response to being polled by the AP;
transmitting, at a time selected by the AP, a downlink frame including polling information to the wireless station on the channel, the polling information including a permitted duration for the wireless station to access the channel; and
monitoring the channel, during the permitted duration, for the AP to receive an uplink transmission from the wireless station, the uplink transmission from the wireless station being in response to the polling information received by the wireless station.

2. The method of claim 1, further comprising:
receiving uplink data in the uplink transmission from the wireless station on the channel;
transmitting an acknowledgment to the wireless station that the uplink data has been received; and
selecting a next wireless station from the plurality of wireless stations associated with the AP for the AP to poll before an end of the permitted duration.

3. The method of claim 1, further comprising:
determining that the permitted duration has expired before the uplink transmission is correctly received by the AP; and
selecting, in response to the permitted duration expiring, a next wireless station from the plurality of wireless stations associated with the AP for the AP to poll.

4. The method of claim 1, wherein the downlink frame further includes downlink data.

5. The method of claim 1, further comprising determining that the channel is free before transmitting the downlink frame.

6. The method of claim 1, wherein transmitting the downlink frame occurs without determining that the channel is free.

7. The method of claim 1, wherein the polling information includes an address of the wireless station.

8. The method of claim 1, wherein selecting the wireless station for the AP to poll is based at least in part on round robin selection from the plurality of wireless stations associated with the AP.

9. The method of claim 1, wherein selecting the wireless station for the AP to poll is based at least in part on a priority of the wireless station.

10. The method of claim 1, wherein selecting the wireless station for the AP to poll is based at least in part on a prediction of a type of uplink data in the uplink transmission from the wireless station.

11. The method of claim 1, further comprising:
receiving, in the uplink transmission from the wireless station, a channel measurement of a neighbor AP;
determining that the wireless station should be handed over to the neighbor AP based on the channel measurement;
sending a handover command to the wireless station in a second downlink frame on the channel, the handover command indicating to the wireless station to change to a second channel of the neighbor AP; and
sending a handover update to the neighbor AP in response to receiving an acknowledgment of the handover command from the wireless station, the handover update indicating that the wireless station is now associated with the neighbor AP.

12. The method of claim 11, further comprising:
sending a transfer request to the neighbor AP identifying the wireless station for a handover; and
receiving a transfer response from the neighbor AP accepting the handover of the wireless station.

13. The method of claim 11, further comprising receiving an indication that the wireless station will switch channels, wherein sending the handover update is further in response to receiving the indication.

14. The method of claim 1, further comprising:
receiving a transfer request from a neighbor AP for an additional wireless station to the plurality of wireless stations associated with the AP;
determining that the AP can accept the additional wireless station;
sending a transfer response to the neighbor AP indicating acceptance of the additional wireless station;
receiving a handoff update indicating that the additional wireless station has been handed over; and
selecting the additional wireless station for the AP to poll after receiving the handoff update.

15. A method of wireless communications, comprising:
monitoring, by a wireless station, a wireless channel for a first downlink transmission from a first access point (AP);
determining that the first downlink transmission includes polling information identifying the wireless station and a permitted duration for the wireless station to access the wireless channel; and
transmitting an uplink transmission on the wireless channel within the permitted duration based on the polling information.

16. The method of claim 15, further comprising transmitting an acknowledgment of the first downlink transmission on the wireless channel.

17. The method of claim 15, further comprising:
monitoring for an acknowledgment of the uplink transmission; and
retransmitting the uplink transmission when an acknowledgement is not received within a time period.

18. The method of claim 15, further comprising:
determining a first modulation rate for the uplink transmission; and
determining a second modulation rate for an uplink retransmission, wherein the second modulation rate is lower than the first modulation rate, and wherein the uplink transmission and the uplink retransmission are transmitted within the permitted duration.

19. The method of claim 18, wherein the first modulation rate and the second modulation rate are selected such that a product of an estimated frame error rate of the uplink transmission and an estimated frame error rate of the uplink retransmission is less than a target frame error rate.

20. The method of claim 15, further comprising:
receiving a medium access control (MAC) layer frame from an application for the uplink transmission, wherein transmitting the uplink transmission comprises transmitting the MAC layer frame.

21. The method of claim 20, wherein the MAC layer frame from the application includes a header including a destination address field, a downlink MCS field, and a more data field.

22. The method of claim 15, further comprising:
determining that the first downlink transmission further includes application data; and
interrupting a host processor in the wireless station to provide the application data to an application running on the host processor without aggregating the first downlink transmission with another downlink transmission.

23. The method of claim 15, further comprising keeping a host processor in the wireless station active by passing all traffic received on the wireless channel to the host processor regardless of an application traffic duty cycle.

24. The method of claim 15, further comprising:
maintaining a neighbor list table including connection information for a plurality of APs in a network including the first AP and a neighbor AP, the neighbor list table including channels used by each of the plurality of APs;
determining a signal strength for the neighbor AP using a channel measurement transceiver;
reporting the signal strength in the uplink transmission;
receiving a handoff command in a second downlink transmission indicating a second channel of the neighbor AP;
switching to the second channel; and
receiving a third downlink transmission including new polling information identifying the wireless station from the neighbor AP on the second channel.

25. The method of claim 15, further comprising:
performing a random access procedure to connect to an authentication AP on a dedicated boot-up channel; and
performing a handover from the authentication AP to the first AP prior to any communication between the wireless station and the first AP.

26. The method of claim 25, further comprising:
determining that the wireless station has lost a connection to the first AP; and
reconnecting to the authentication AP on the dedicated boot-up channel.

27. An apparatus for wireless communications, comprising:
a transceiver;
a memory that stores instructions; and
a processor communicatively coupled to the transceiver and the memory, the processor configured to execute the instructions to:
select, from a plurality of wireless stations associated with an access point (AP), a wireless station for the AP to poll, wherein each of the plurality of wireless stations is configured to transmit on a channel in response to being polled by the AP;
transmit, via the transceiver, at a time selected by the AP, a downlink frame including polling information to the wireless station on the channel, the polling information including a permitted duration for the wireless station to access the channel; and
monitor the channel, during the permitted duration, for the AP to receive an uplink transmission from the wireless station on the channel, the uplink transmission from the wireless station being in response to the polling information received by the wireless station.

28. The apparatus of claim 27, wherein the processor is configured to execute the instructions to:
receive, via the transceiver, uplink data in the uplink transmission from the wireless station on the channel;
transmit, via the transceiver, an acknowledgment to the wireless station that the uplink data has been received; and
select a next wireless station from the plurality of wireless stations associated with the AP for the AP to poll before an end of the permitted duration.

29. An apparatus for wireless communications, comprising:
a transceiver configured to monitor a wireless channel for a first downlink transmission from a first access point (AP) to a wireless station;
a memory that stores instructions; and
a processor communicatively coupled to the memory, wherein the processor is configured to execute the instructions to:
determine that the first downlink transmission includes polling information identifying the wireless station and a permitted duration for the wireless station to access the wireless channel; and
transmit an uplink transmission on the wireless channel within the permitted duration based on the polling information.

30. The apparatus of claim 29, wherein the processor is configured to execute the instructions to:
determine a first modulation rate for the uplink transmission; and
determine a second modulation rate for an uplink retransmission, wherein the second modulation rate is lower than the first modulation rate, and wherein the uplink transmission and the uplink retransmission are transmitted within the permitted duration.
